(19) United States
(12) Patent Application Publication
(10) Pub. No.: US 2025/0192182 A1
(43) Pub. Date: Jun. 12, 2025

(54) CHEMICAL CROSSLINKING OF PVDF BINDER FOR BATTERY ELECTRODES

(71) Applicant: UNIVERSITY OF SOUTH CAROLINA, COLUMBIA, SC (US)

(72) Inventors: AVINASH RAULO, COLUMBIA, SC (US); GOLAREH JALILVAND, COLUMBIA, SC (US)

(21) Appl. No.: 18/909,338

(22) Filed: Oct. 8, 2024

Related U.S. Application Data
(60) Provisional application No. 63/608,377, filed on Dec. 11, 2023.

(51) Int. Cl. H01M 4/62; H01M 4/04; H01M 4/13; H01M 4/38

(52) U.S. Cl. CPC H01M 4/623; H01M 4/0404; H01M 4/13; H01M 4/38; H01M 4/625

(57) ABSTRACT

In general, the present disclosure is directed to methods for producing an electrode having a crosslinked binder. In some embodiments the binder may comprise polyvinylidene fluoride. Said crosslinking may allow for higher loading capacities, increased ionic conductivity and/or durability. Further, electrodes and batteries comprising said electrodes which have crosslinked binders are described herein.

### CROSS REFERENCE TO RELATED APPLICATION

This application claims filing benefit of U.S. Provisional Patent Application Ser. No. 63/608,377, having a filing date of Dec. 11, 2023, which is incorporated herein by reference in its entirety.

### BACKGROUND

Various materials are promising alternatives to presently utilized electrodes in lithium-ion batteries. For instance, sulfur is a promising candidate for next-generation cathodes in lithium battery systems, and lithium-sulfur (Li—S) batteries are one of the promising alternatives for current lithium-ion battery (LIB) technology due to their superior specific energy density, which can satisfy the emerging needs of advanced energy storage applications such as electric vehicles and grid-scale energy storage and delivery. However, achieving this high specific energy density is hampered by several challenges inherent to the properties of sulfur and its discharge products.

One major issue is related to the insulating nature of sulfur and its fully discharged product (Li₂S), which often leads to low utilization of the active material and poor rate capability. The poor electronic conductivity of these species can be overcome by utilizing conductive hosts, though they are dilutive and decrease the energy density, meaning that their mass ratio to the active material should be as low as possible.

Another issue relates to the undesired solubility of certain sulfur discharge products, so-called long-chain Li polysulfides (LiPSs), in the conventional ether-based liquid electrolyte. The solubility of long-chain LiPSs promotes their free back and forth transportation between the positive and negative electrodes, which results in poor cyclability and capacity decay. Lastly, sulfur goes through a large volume expansion and contraction during lithiation and delithiation that leads to mechanical degradation in the cathode over long duration cycling. Despite the efforts to engineer and control the undesired LiPSs shuttling effect and volume variation-induced degradations, the advances have been mostly limited to a small number of cycles (100-200), or to the need for complex and often expensive synthesis that has limited the rational development of new sulfur cathodes.

Simultaneously, increasing demand for increased volumetric and gravimetric density have required an increase in electrode thickness in order to sustain increased electrode active material loading. However, said thick electrodes suffer greatly from the issues described above, particularly with respect to volume expansion and contraction.

At present, a large majority of the sulfur cathode research has focused on nano-architectured electrodes using 2D and 3D host materials for sulfur, such as carbon nanotubes, graphene, conductive scaffolds, yolk-shell structures, and the like, to increase the conductivity, alleviate the LiPSs shuttling, and accommodate the volume variation during discharge. Although these approaches have helped to increase the achievable capacity, and sometimes the cyclability, their synthesis methods have been highly complex, meaning that their manufacturing cost will be high. Also, in operating cells, it is highly unlikely that these complex structures can be effectively reproduced upon many charge-discharge cycles-meaning that capacity loss is essentially inevitable. Thus, developing novel, yet affordable and scalable, cathode architectures that can enhance the rapid transport of Li-ions to active sites for electrode reactions, accommodate discharge-induced volume expansion, and minimize the shuttling mechanism by sulfur encapsulation are still in great need. Relatively simple and low-cost processing methods to create electrodes that allow for significantly improved cycling and lifetime would be of great benefit in the art.

### SUMMARY

In general, the present disclosure is directed to methods for making electrodes having crosslinked electrode binders. For instance, a presently described method for forming an electrode comprises dissolving a binder into an organic solvent to provide a dissolved binder and adding to the dissolved binder an aqueous solution comprising a metal hydroxide to form a crosslinked binder solution.

Furthermore, the present disclosure describes various electrodes comprising an electrode layer comprising a binder comprising a crosslinked polyvinylidene fluoride having an ionic conductivity greater than 2.5×10⁻⁵ S cm⁻¹, an electrode active material mixed with the binder, and a current collector that is coated with the electrode layer.

Further, in some embodiments of the present disclosure, described herein is a battery comprising first and second electrodes, wherein at least one of the electrodes comprise an electrode layer comprising a crosslinked polyvinylidene fluoride binder and an electrode active material, and wherein the first and second electrodes comprise first and second current collectors. Furthermore, the battery comprises a separator disposed between the first and second electrodes, an electrolyte in contact with the first and second electrodes and the separator, and a housing retaining the first and second electrodes, the electrolyte and the separator.

These and other features and aspects, embodiments and advantages of the present invention will become better understood with reference to the following description and appended claims.

### BRIEF DESCRIPTION OF THE FIGURES

A full and enabling disclosure of the present disclosure is set forth more particularly in the remainder of the specification, including reference to the accompanying figures, in which:

FIG. 1 is an XPS survey spectrum of PVDF and PVDF-LiOH cast films.

FIG. 2 is a high resolution XPS spectrum of the C 1s spectrum of PVDF and PVDF-LiOH.

FIG. 3 is a high resolution XPS spectrum of the O 1s spectrum of PVDF and PVDF-LiOH.

FIG. 4 is a high resolution XPS spectrum of the F 1s spectrum of PVDF and PVDF-LiOH.

FIG. 5 is a high resolution XPS spectrum of the Li 1s spectrum of PVDF and PVDF-LiOH.

FIG. 6 is the solid state ¹⁹F NMR spectra of PVDF and PVDF-LiOH cast films. Lines are shown in the legend in the manner in which they are stacked.

FIG. 7 is a comparison of the FTIR spectra of PVDF and PVDF-LiOH cast films, as well as pristine PVDF powder. Lines are shown in the legend in the manner in which they are stacked.

FIG. 8 is an FTIR spectrum of PVDF-LiOH cast film.

FIG. 9 is a comparison of the XRD spectra of PVDF and PVDF-LiOH cast films. Lines are shown in the legend in the manner in which they are stacked.

FIG. 10 is a comparative stress-strain curve of PVDF and PVDF-LiOH cast films.

FIG. 11 is a comparative DSC heating profile of PVDF and PVDF-LiOH cast films.

FIG. 12 is a comparative TGA thermogram of PVDF and PVDF-LiOH cast films.

FIG. 13 is a comparative graph of ionic conductivity as measured from the EIS profile of the PVDF and PVDF-LiOH cast films.

FIG. 14 is an SEM image of S@PVDF cast film.

FIG. 15 is a magnification of the SEM image shown in FIG. 14.

FIG. 16 is an SEM image of S@PVDF-LiOH cast film.

FIG. 17 is a magnification of the SEM image shown in FIG. 16.

FIG. 18 is a magnification of the SEM image shown in FIG. 17. Specifically, FIG. 18 shows several bridges of crosslinked binder.

FIG. 19 is a graph of cyclic voltammetry of an S@PVDF electrode.

FIG. 20 is a graph of cyclic voltammetry of an S@PVDF-LiOH electrode.

FIG. 21 is a graph showing the cycle performance at a 0.1 C-rate for the S@PVDF electrode and the S@PVDF-LiOH electrode.

FIG. 22 is a graph showing the cycle performance of S@PVDF and S@PVDF-LiOH electrodes prior to cycling.

FIG. 23 is a graph showing the cycle performance of S@PVDF and S@PVDF-LiOH electrodes after 50 cycles.

FIG. 24 is a graph showing the initial charge-discharge curve of lithium sulfur batteries at a 0.1 C-rate for the S@PVDF and S@PVDF-LiOH electrodes.

FIG. 25 is a graph of galvanostatic charge-discharge curves showing performance of the S@PVDF-LiOH after 200 cycles.

FIG. 26 is a graph of galvanostatic charge-discharge curves showing performance of the S@PVDF after 91 cycles.

FIG. 27 is an SEM photograph of a S@PVDF cathode after 50 cycles.

FIG. 28 is an SEM photograph of a S@PVDF-LiOH cathode after 50 cycles.

FIG. 29 is the Raman spectrum of the anode facing side of separators extracted from their corresponding, S@PVDF and S@PVDF-LiOH cathodes.

FIG. 30 is an SEM photograph of a lithium anode extracted from a cell with a S@PVDF cathode after 50 cycles.

FIG. 31 is an SEM photograph of a lithium anode extracted from a cell with a S@PVDF-LiOH cathode after 50 cycles.

FIG. 32 is a graph comparing the cycle performance of S@PVDF, S@PVDF-LiOH (95:5) and S@PVDF-LiOH (90:10) cathodes having areal sulfur loadings of ˜3.3 mg cm⁻².

FIG. 33 is a graph showing the cycle performance of a lithium sulfur battery coin cell with a S@PVDF-LiOH cathode having a sulfur areal loading of 4 mg cm 2.

FIG. 34 is a graph showing the cycle performance of a lithium sulfur battery with a S@PVDF-LiOH cathode in a pouch cell form factor.

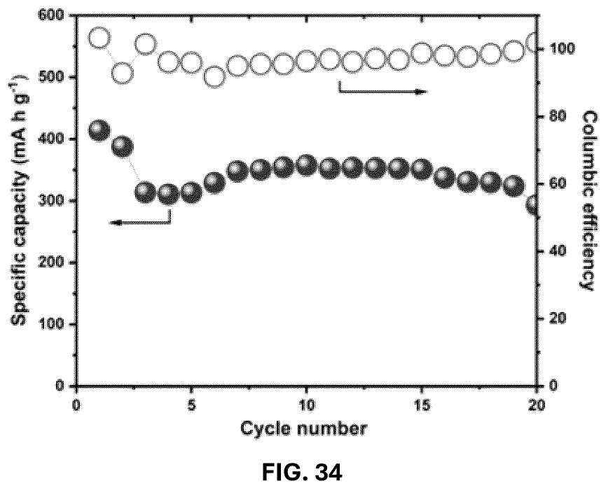

Repeat use of reference characters in the present specification and figures is intended to represent the same or analogous features or elements of the present disclosure.

### DETAILED DESCRIPTION

Reference will now be made in detail to example embodiments of the disclosure. It is to be understood by one of ordinary skill in the art that the present disclosure is a description of exemplary embodiments only and is not intended as limiting the broader aspects of the present disclosure.

The present disclosure provides methods for crosslinking the binder of an electrode. For instance, in some embodiments of the present disclosure, the method generally comprises the step of dissolving a binder in a solvent. Thereafter, a metal hydroxide is dissolved into a solvent. The two solutions are then combined, leading to the crosslinking of the dissolved binder. In some embodiments of the present disclosure, the method may further comprise adding an electrode active material to the binder solution to form an electrode slurry. Said electrode slurry may be referred to as a cathode slurry or an anode slurry depending on the composition of the electrode slurry. Regardless, the electrode slurry may be deposited onto a current collector to form an electrode layer on the current collector.

Generally speaking, the present disclosure is directed to an electrode including a crosslinked binder and a method of making the same. The present inventors have discovered that when such electrode is utilized in a battery comprising an electrochemical cell, the battery is capable of withstanding high voltages for a large number of cycles. Additionally, said battery may be capable of having high areal loadings of electrode active material. As described above, lithiation or de-lithiation may cause volume expansion or contraction within some electrode active materials. Without wishing to be bound to any particular theory, it is believed that this expansion and contraction, particularly for electrodes which undergo many cycles, e.g., in rechargeable batteries, may cause cracking within the electrode. Cracking within the electrode can be problematic for a variety of reasons. For example, cracking of an electrode may cause the internal resistance of the electrode to increase, decreasing the overall efficiency of a battery which incorporates the cracked electrode. Furthermore, cracking can decrease the overall capacity of the electrode.

The present disclosure teaches batteries which comprise electrodes which may have reduced vulnerability to some or all of the above stated issues. For instance, said battery may comprise, among other things, an anode and a cathode. The said anode and cathode may comprise an electrode active material, a binder and optionally conductive material and/or additives. The binder may comprise a crosslinked polymer. The crosslinked polymer may allow for some or all of the previously described benefits, including, but not limited to, decreased cracking within the electrode due to increased mechanical compliance, higher areal electrode active material loading, increased cyclability and increased ionic conductivity. Without wishing to be bound to any particular theory, a small degree of crosslinking allows for an increase in tensile strength of the binder, while maintaining a high degree of flexibility.

Binders are commonly used in lithium-ion batteries, as many lithium-ion batteries are formed from electrode active materials which are initially in a powdered form. Thus, the binder may serve to adhere the powdered materials into a single mass. Polyvinylidene fluoride is one such binder which is commonly used for lithium-ion batteries.

Polyvinylidene fluoride is a thermoplastic fluoropolymer which is typically unreactive given its high number of fluorinated carbons. It is often used as a binder in lithium-ion batteries due to its thermal stability, resistance to oxidation low reactivity and lack of reactivity with solvents, particularly with the solvent often used for the electrolyte. Furthermore, polyvinylidene fluoride has good stability under high voltage, e.g., 0 to 5 volts Li/Li⁺. Polyvinylidene fluoride may have a molecular weight of between 500 kDa and 500,000 kDa, such as between 25,000 kDa and 300,000 kDa, such as between 75,000 kDa and 150,000 kDa. In some embodiments, the polyvinylidene fluoride may have a molecular weight of between 1000 kDa and 100,000 kDa. Furthermore, the polyvinylidene may be provided such that 40 wt. % of the total weight of polyvinylidene fluoride has a molecular weight greater than 75,000 kDa and less than 125,000 kDa, and the remaining 60 wt. % has a molecular weight less than 10,000 kDa and greater than 500 kDa.

As described above, binders for use in the presently described electrodes and electrode layers include polyvinylidene fluoride. Further, the binder may comprise a blend or copolymer of polyvinylidene fluoride with binders known in the art, examples of which can include, without limitation, polytetrafluoroethylenes (PTFE), carboxymethyl cellulose (CMC), rubbers such as styrene butadiene rubber (SBR) and natural latex rubbers, polyacrylic acids (PAA) such as lithium polyacrylate (LiPAA), polyurethanes, ethylene vinyl acetates, polyacrylamides, starches, acrylonitrile copolymer, polyacrylonitrile, poly(vinylidene fluoride)-hexafluoropropene. Thus, in some embodiments, the binder may comprise polyvinylidene fluoride. In one particular embodiment, the binder may comprise crosslinked polyvinylidene fluoride. However, one of skill in the art could envisage employing a mixture of binders for either of the anode or cathode depending on the binder attributes which are sought. For instance, a mixture of binders comprising the polyvinylidene fluoride and at least one of the alternative binders disclosed above may comprise greater than 50 wt. % and less than 95 wt. % of polyvinylidene fluoride, such as greater than 65 wt. % and less than 80 wt. %, such as greater than 70 wt. % and less than 75 wt. %, and greater than 5 wt. % and less than 50 wt. % of at least one of the alternative binders disclosed above, such as greater than 20 wt. % and less than 35 wt. %, such as greater than 25 wt. % and less than 30 wt. %.

In some embodiments of the present disclosure, the initially un-crosslinked binder (e.g., in an uncured or un-crosslinked state) may be dissolved in a solvent. For instance, the binder may be dissolved in a solvent comprising n-methyl pyrrolidone (NMP). Furthermore, other solvents, such as dimethylformamide (DMF), tetrahydrofuran (THF), chloroform, acetone, or mixtures thereof may be used. For instance, as a non-limiting example of the presently disclosed method, polyvinylidene fluoride may be dissolved in n-methyl pyrrolidone. In some embodiments of the present disclosure, the binder may be dissolved in the solvent on a wt./vol. basis of between 5 mg/ml and 30 mg/mL, such as between 10 mg/mL and 20 mg/mL, such as between 12 mg/mL and 18 mg/mL. The cyclability of Li—S batteries that incorporate an electrode formed as described herein can be improved through control of the dissolution level of the binder into the processing solvent. The result may be a longer battery life, allowing these cells to penetrate into new applications.

The binder may be present in the electrode layer in an amount of from about 1% by weight to about 15% by weight, such as from about 2.5% by weight to about 12.5% by weight, such as from about 5% by weight to about 10% by weight, or any range therebetween based on the weight of the electrode layer.

In some embodiments of the present disclosure, crosslinking of a polyvinylidene fluoride binder may be performed by the addition of a metal hydroxide. Without wishing to be limited to any particular theory as to the mechanism of crosslinking of the polyvinylidene fluoride, the metal hydroxide may lead to the initiation of dehydrofluorination and free-radical formation. Said free radicals may then form crosslinks.

Metal hydroxides which may lead to crosslinking include, but are not limited to, hydroxides of lithium, sodium, potassium, calcium, zinc, magnesium, aluminum, or mixtures thereof. For instance, in some embodiments of the present invention, the metal hydroxide may be chosen depending on the desired electrolyte of the battery. As a non-limiting example, lithium hydroxide may be used for a battery which uses lithium-ions as part of the electrolyte.

The metal hydroxide may be dissolved in a solvent, such as an aqueous or organic solvent. For instance, a metal hydroxide comprising lithium hydroxide may be dissolved in water. In some embodiments of the present disclosure, the metal hydroxide may be dissolved in the aqueous solvent on a wt./vol. basis of between 0.5 mg/mL and 5 mg/mL, such as between 1 mg/mL and 2 mg/mL.

In some embodiments of the present disclosure, the dissolved binder and dissolved metal hydroxide when mixed together may have a specific weight ratio. For instance, said weight ratio of binder to metal hydroxide may be between 99:1 and 9:1, such as between 50:1 and 15:1, such as between 25:1 and 18:1, such as 19:1.

However, one of skill in the art will appreciate that this weight ratio may vary depending on the oxidation state of the metal in the metal hydroxide. For instance, should the metal hydroxide comprise a multi-valent ion such as zinc or calcium, the ratio of the metal hydroxide and the binder may be adjusted.

The electrode and/or the electrode slurry and/or electrode layer may comprise an electrode active material. For instance, an electrode active material may comprise sulfur, manganese, nickel, iron, cobalt, lithium, titanium, allotropes of carbon such as graphite and graphene, silicon or mixtures thereof, and oxides, nitrides and phosphates thereof where applicable. Generally, however, it will be appreciated by one of skill in the art that the present method is not particularly limited by the composition of the electrode active material, as the present method enables a wide variety of electrode active materials to be used, even when said material may have significant volume expansion or contraction during lithiation or de-lithiation. Furthermore, in some embodiments of the present disclosure, a first and second electrode comprising the cathode and anode may comprise first and second electrode active materials which are distinct. That is, the cathode may comprise sulfur, and the anode may comprise a mixture of silicon and graphite, as is disclosed above.

In some embodiments of the present disclosure, the cathode active material may comprise sulfur. In one embodiment, the sulfur cathode may include a sulfur-containing source. For instance, the sulfur-containing source may include, but is not limited to, sulfur particles in the form of a powder. In one embodiment, sulfur particles can be present in the cathode (or cathode layer) in an amount of from about 50% by weight to about 98% by weight, such as from about 55% by weight to about 75% by weight, such as from about 60% by weight to about 70% by weight, or any range therebetween. For instance, sulfur particles may be present in the cathode at a concentration of 70% by weight.

In some embodiments of the present disclosure, an electrode may have a specific areal loading of sulfur within the electrode. For example, the cathode may have an areal loading of sulfur greater than 2 mg cm 2, such as greater than 3 mg cm⁻², such as greater than 3.5 mg cm 2, such as greater than 4 mg cm⁻², such as greater than 4.5 mg cm⁻² of sulfur.

In some embodiments of the present disclosure, the electrode active material, such as the cathode active material, may be a metal oxide intercalation active material as is known in the art, such as lithium nickel manganese cobalt oxide, lithium nickel oxide, lithium manganese oxide spinel and lithium cobalt oxide. The electrode, such as the cathode, in particular the electrode layer, can include a metal oxide compound and an electrolyte/binder that can provide ionic transport or can include only the metal oxide intercalation material, as desired.

The metal oxide cathode active material can be prepared having a unit structure characterized by the ability to insert lithium-ion in an electrochemical reaction. Such compounds are referred to as intercalation compounds and include transition metal oxides having reversible lithium insertion ability. The transition metal of the cathode active material can include one or more of V, Co, Mn, Fe, and Ni.

In some embodiments of the present disclosure, the electrode active material can be pre-processed to prepare small-sized particles and de-agglomerating them before electrode fabrication. For instance, the electrode active material may range in size from about 1 μm to about 40 μm, such as from about 5 μm to about 35 μm, such as from about 10 μm to about 25 μm, or any range therebetween.

In some embodiments of the present disclosure, the electrode active material may be present at 50% wt. % to 98% wt. %, such as 55% wt. % to 75% wt. %, such as 60% wt. % to 70% wt. %, such as 70 wt. % or any range therebetween based on the weight of the electrode layer.

Furthermore, the weight ratio of the electrode active material to the binder, in particular the crosslinked binder, may be greater than 5 to 1 and less than 30 to 1, such as greater 6 to 1 and less than 20 to 1, such as greater than 7 to 1 and less than 15 to 1, such as greater than 8 to 1 and less than 13 to 1.

In addition to the prior described materials, electrodes and/or electrode slurries and/or electrode layers as disclosed herein may comprise a conductive material. The conductive material may serve to increase the conductivity of the electrodes with respect to the current collector. For instance, the conductive material may comprise carbon, metal, alloys, or mixtures thereof.

In embodiments wherein the conductive material comprises carbon, the carbon particles may comprise carbon black, activated carbon, carbon nanotubes (e.g., multi-walled carbon nanotubes), carbon fibers, graphitized carbon, mesoporous carbon, or mixtures thereof. The utilization of the electrode active material can also be increased by increasing electronic conductivity through the utilization of carbons with higher surface areas, such as carbon black having a surface area greater than 1200 m² g⁻¹ as measured by BET.

In general, the conductive material is present in the electrode layer at a concentration of from about 1% to about 25% by weight, such as from about 5% by weight to about 22% by weight, such as from about 10% by weight to about 20% by weight, such as from about 12.5% by weight to about 15% by weight, or any range therebetween based on the weight of the electrode layer.

In one embodiment, a cathode or cathode layer may comprise sulfur, carbon black, and polyvinylidene fluoride (PVDF) binder. For instance, the sulfur may comprise greater than 60 wt. % but less than 80 wt. %, the carbon may comprise greater than 10 wt. % and less than 30 wt. %, and the binder may comprise greater than 10 wt. % and less than 30 wt. %, wherein the wt. % of the sulfur, carbon and binder add to 100 wt. %. In one embodiment, the ratio of sulfur-to-carbon-to-binder is about 70:20:10. For instance, in some embodiments, a cathode or cathode layer may comprise sulfur, carbon black, multi-walled carbon nanotubes and binder in a ratio of 70:10:10:10 respectively.

The electrode active material, binder and optional conductive material may be combined as briefly described above. For instance, the binder may be dissolved in solvent. The metal hydroxide may then be dissolved in a solvent. The dissolved binder and dissolved metal hydroxide may then be combined in order to crosslink the binder, thus forming a crosslinked binder. Thereafter, electrode active material and optional conductive material may be added to the crosslinked binder, thus forming an electrode slurry.

In addition to the methods described above, in some embodiments of the present disclosure, the electrode active material and the conductive material may be processed in a manner similar to what is described in WO 2023/229728 A2, which is fully incorporated herein. Briefly, the method may comprise dry mixing electrode active material and a binder; adding a carbon source to the dry mixture; contacting the resulting dry mixture comprising the carbon source, the electrode active material, and the binder with a solvent to form an electrode slurry, crosslinking the binder by addition of a metal hydroxide; and removing the solvent from the electrode slurry to form the electrode, wherein the electrode comprises a porous shell structure covering the electrode active material.

However, it should be understood that other methods of making the electrode slurry and/or electrode layer may also be utilized as generally known in the art. For instance, any one or more components may be provided with a liquid, such as a solvent, in forming the electrode slurry and/or electrode layer. Accordingly, such method may not particularly be directed to dry mixing. However, it should be understood that the method of making the electrode slurry and/or electrode layer is not limited by the present disclosure.

The electrodes as described above may be part of an electrochemical cell. The electrochemical cells can provide high-energy density, high cycling rates (high power capability) and safe battery technology. The electrochemical cells can be used to form lightweight metal-supported solid-state lithium-ion batteries that can meet existing challenges in battery technology. Moreover, the electrochemical cells can find immediate applications in electric vehicles, aerospace applications, and in renewable and grid energy storage, among others.

In one embodiment, the electrochemical cell may include an electrolyte. For instance, the electrolyte may include, but is not limited to, lithium bis(trifluoromethane) sulfonimide (LiTFSI), lithium hexafluorophosphate (LiPF6), lithium nitrate, lithium perchlorate, lithium tretrafluoroborate, lithium bis(trifluoromethanesulfonyl)imide, or a combination thereof. Furthermore, the electrolyte may be dissolved in a solvent. In embodiments wherein the electrolyte comprises lithium or lithium-ions, the solvent of the electrolyte may comprise an organic solvent. For instance, the solvent may comprise 1,3-dioxolane (DOL), 1,2-dimethoxyethane (DME), carbonates such as ethylene carbonate (EC), diethyl carbonate (DC), dimethyl carbonate (DMC) and ethyl methyl carbonate (EMC), or mixtures thereof.

In some embodiments of the present disclosure wherein the electrode active material comprises sulfur, the sulfur within an electrode layer may have a specific ratio with respect to the electrolyte. For instance, the electrochemical cell may have a sulfur to electrolyte ratio of greater than 9 mg μL⁻¹, such as greater than 9.5 mg μL⁻¹, such as greater than 10 mg μL⁻¹, such as greater than 10.5 mg μL⁻¹, such as greater than 11 mg μL⁻¹.

Further, the electrochemical cell may comprise a separator. The separator is typically disposed between the first electrode and the second electrode, such as the anode and the cathode, and may have a very high resistance to current relative to the external circuit of the battery. However, the separator is permeable to ions generated during oxidation and reduction. This configuration therefore allows for electrons to pass through the external circuit, typically used to power some device, while maintaining charge neutrality via the flow of ions through the separator. Said separator may comprise a polyolefin, such as polypropylene (PP), polyethylene (PE), copolymers thereof, ion exchange resins, or cellulose-derived materials. Commonly used in lithium-ion batteries are polypropylene separators. However, one of skill can envisage using copolymers or blended separators, for instance comprising polypropylene and polyethylene depending on the attributes of the separator which are sought.

Additionally, the electrochemical cells as described herein may further comprise current collectors. Current collectors can be used in order to aid the flow of electrons from the electrode active material to the external circuit. The current collector may be formed of a sheet of a conductive material. For instance, the current collector may include, but is not limited to, aluminum, carbon paper, copper, nickel, titanium, stainless steel or alloys or mixtures thereof. As a non-limiting example, the anode slurry may be coated on a current collector of copper, while the cathode slurry may be coated on a current collector of aluminum.

The electrode slurry may be coated onto the current collector by a variety of methods, including but not limited to, spray coating, doctor blading, slot die coating, gravure coating and screen printing. The method used to coat the electrode slurry during formation of an electrode can also be used to provide further improvement to the electrode.

For instance, in some embodiments, spraying involves layer-by-layer dispersion and deposition of a well-mixed electrode slurry onto the current collector. The spraying may be done using an airbrush. The layer can then be allowed to dry (e.g., at 100° C.) before another layer of slurry is sprayed and dried. The process can be repeated until the desired loading is achieved. Lastly, the electrode can be held under vacuum for 48 hours to ensure that all the solvent is removed. Spray coating can be used to form a highly porous electrode. It is also worth noting that when the spray-coated electrodes are formed, only a small amount of slurry is used in each step, and drying occurs almost instantly due to the heat and low overall volume of solvent per step. This means that the electrode is never really in a high liquid state (excess solvent) during its formation. Alternatively, using the conventional doctor blade technique can result in a denser electrode.

Alternatively, the coating method used to coat the current collector may be the doctor blade technique. In this embodiment, a current collector substrate can be placed onto a vacuum table in an enclosure to hold it in place. The homogeneous and well-mixed slurry can be placed onto the current collector. The blade can then be slowly moved along the substrate, spreading the slurry on the current collector to form a uniform thin layer. The electrode can then be dried, e.g., at room temperature. Because the layer can be dense and drying need not be aided with heat, the doctor blade electrodes can have longer drying times than the spray coated electrodes. During the doctor blade deposition, all of the slurry is spread on the current collector at once and drying occurs from a high liquid state.

In one embodiment, the electrochemical cell may be a battery as known in the art. A battery may include one or more of the cells sealed into a case according to standard methodology. For instance, the battery may be a lithium-sulfur battery. As a non-limiting example, the presently described electrodes comprising a crosslinked binder may be used as part of an electrochemical cell in a variety of form factors, such as a coin cell, pouch cell, prismatic cell or cylindrical cell.

Furthermore, certain aspects of the present disclosure may be better understood according to the following examples, which are intended to be nonlimiting and exemplary in nature.

### EXAMPLES

### Crosslinking of PVDF

To prepare the crosslinked PVDF binder, 47.5 mg PVDF was added to 3 ml NMP and stirred for 5 h to form a homogeneous PVDF solution. In a separate vial, 2.5 mg LiOH was dissolved in 1 ml de-ionized (DI) water to form an aqueous solution of LiOH. 1 ml of LiOH aqueous solution was gradually added to the PVDF solution under continuous stirring to form the crosslinked binder (referred to herein as “PVDF-LiOH” solution). The weight ratio of PVDF to LiOH (PVDF:LiOH) was maintained at 95:5 unless otherwise stated. The standard PVDF solution was prepared by dissolving 50 mg of PVDF in 4 ml of NMP and stirred for 5 h. To prepare the standard PVDF and PVDF-LiOH cast films, the PVDF and PVDF-LiOH solutions were each cast in a flat stainless-steel plate and dried under vacuum for 24 h at 50° C.

### Fabrication of Sulfur Cathode

First, calculated amounts of sulfur, Ketjen black, and MWCNT were dry mixed. This dry mix was heated for 12 hours at 155° C. In the meantime, the binder solution was made using the same procedure for the PVDF-LiOH and PVDF solution preparation, described earlier. The sulfur/Ketjen black/MWCNT mixture was then added to the PVDF-LiOH or PVDF solution to form the cathode slurry while maintaining the sulfur:Ketjen black:MWCNT:binder mass ratio at 70:10:10:10. The sulfur cathodes with different binders were prepared by coating the slurries on a TGP-H-60 carbon paper using the conventional doctor blade method and drying the slurry-coated electrodes in a vacuum oven for 24 h at 50° C.

### Materials Characterization

Electron paramagnetic resonance (EPR) spectra were collected from PVDF and PVDF-LiOH cast films at ambient temperature using a Bruker EMXplus X band spectrometer. A 200-Gauss window was collected with a 30 s sweep time. Field modulation amplitude of 1 Gauss was used at a frequency of 100 kHz. 2 mW of microwave power was used with the cavity tuned to 9.770106 GHZ. In addition to EPR, solid-state nuclear magnetic resonance (NMR) was also conducted on the PVDF and PVDF-LiOH cast films using a Bruker Avance III-HD 500 MHz spectrometer fitted with a 1.9 mm MAS probe. The solid-state ¹⁹F MAS and ¹³C cross-polarization (CP)-MAS spectra were collected at ambient temperature. The solid state ¹⁹F MAS spectra were collected with a sample rotation rate of 30 KHz. Bloch decays were collected with a 236 msec acquisition time over 300 ppm spectra width with a relaxation delay of 10 s. The solid state ¹³C CP-MAS spectra were collected with a sample rotation rate of 20 KHz. A 2 msec contact time with linear ramping on the ¹H channel and 62.5 kHz field on the ¹³C channel were used for cross-polarization. ¹H dipolar decoupling was performed with SPINAL64 modulation and 145 kHz field strength. Free induction decays were collected with a 20 msec acquisition time over a 350 ppm spectra width with a relaxation delay of 2 s.

For surface characterizations, X-ray photoelectron spectroscopy (XPS) was conducted on PVDF and PVDF-LiOH cast films using a Kratos AXIS Ultra DLD (Kratos Analytical, Manchester, UK) system with a monochromatic Al Kα source (150 Watts) at a 45° incident angle. Attenuated total reflectance Fourier transform infrared (ATR-FTIR) spectroscopy was also carried out within a 4000-650 cm⁻¹ range using an Agilent Cary 630. The spectra were averaged from 32 scans and obtained with at least 16 cm⁻¹ resolution. Furthermore, Raman spectra were collected using a Thermo-Fisher Scientific DXR3 Raman microscopy with a 532 nm wavelength. For complementary compositional studies, X-ray diffraction (XRD) was conducted using a Rigaku diffractometer using Cu Kα radiation (λ=0.154 nm) at a scan rate of 2° C./min.

Mechanical and physical properties of the binder cast films were measured using a Discover Hybrid Rheometer (DHR-2) by TA instruments. The tests were performed on 60 μm thick binder cast films which were cut into 20 mm×10 mm rectangular pieces and mounted via grip heads with a loading gap of 15 mm. The force and displacement data were controlled by a step motor at a motion rate of 15 μm s⁻¹. In addition, DSC7020 Thermal Analysis System (HITACHI) was used to conduct the differential scanning calorimetry (DSC) measurements. Finally, the thermal gravimetric analysis (TGA) was carried out from room temperature to 500° C. at a heating rate of 10° C. min-1 under nitrogen atmosphere in Shimadzu TGA-50 thermal analyzer.

The morphologies of the sulfur cathodes and cycled lithium anodes were characterized with a field-emission scanning electron microscope (FE-SEM, Zeiss Gemini500) equipped with an energy-dispersive X-ray spectrometer (EDS). All microscopy was performed at a working distance of 10-11 mm using a 15 kV acceleration voltage for the electron beam and a secondary electron detector. To study the microstructural evolution of the sulfur cathodes and lithium anodes after cycling, lithium sulfur battery cells were decommissioned after 50 cycles at a fully charged state before disassembly in an argon glove box. The cycled electrodes were mounted on the SEM specimen stubs inside the Argon glove box and transferred to the SEM facility using sealed glass vials and exposed to ambient air for less than 5 sec before transferring into the vacuumed electron beam chamber.

### Electrochemical Measurements

The ionic conductivities of the PVDF and PVDF-LiOH cast films were measured by the AC impedance method. At first, the cast films were soaked by the conventional lithium sulfur battery electrolyte, containing 1 M lithium bis(trifluoromethane sulfonyl)imide (LiTFSI) in a 1:1 v:V mix of 1,3-dioxolane (DOL) and 1,2-dimethoxyethane (DME) solvents and 0.2 M lithium nitrate (LiNO₃). Then, electrolyte-soaked binder films were placed in a symmetrical cell configuration in between two stainless-steel electrodes (16 mm diameter) and assembled in CR2032 coin cells. The impedance data was recorded with a BioLogic MPG-205 electrochemical workstation over the frequency range of 10 mHz-20 KHz at an amplitude of 5 mV.

To study the electrochemical performance of the sulfur cathodes, both coin and pouch cells were prepared by pairing the sulfur cathodes with lithium foil as counter and pseudo reference electrode. Celgard 2400 was used as the separator, and calculated amount of LSB electrolyte maintaining an E/S ratio≤10 UL (electrolyte) mg⁻¹ (sulfur) was added to the cells. The cyclic voltammetry (CV) and electrochemical impedance spectroscopy (EIS) measurements were conducted using a BioLogic VSP-3e electrochemical workstation. Cyclic voltammetry was carried out within a voltage window of 1.7 V-2.8 V (vs Li/Li⁺) at a scan rate of 0.1 mV s⁻¹. EIS spectra were collected under open-circuit condition in the frequency range of 100 kHz to 10 mHz with an AC voltage amplitude of 5.0 mV. The galvanostatic discharge-charge test of the coin and pouch cell was performed within a cut-off voltage window of 1.7 V-2.8 V (vs Li/Li⁺) at ambient temperature using a Neware battery cycler. The current rate in the galvanostatic tests were calculated based on the theoretical capacity of sulfur (i.e., 1 C=1675 mA g⁻¹) and the specific capacities were calculated based on the mass of sulfur present in the cathode.

### XPS and ¹⁹F MAS NMR

During the preparation of binder solutions, it was observed that with the addition of LiOH aqueous solution, the color of the PVDF solution immediately changed from translucent to dark brown. This colored solution—the PVDF-LiOH solution, was stable and exhibited a comparable viscosity to that of the PVDF solution. An additional observation was obtained from the PVDF solution, which exhibited an instant phase separation when the same quantity of DI water was added to it. The stable viscosity of the PVDF solution upon addition of the LiOH aqueous solution is an important phenomenon which verifies the ability of PVDF-LiOH solution as a binder to disperse electrode particles more uniformly than other crosslinked binder solutions which are typically highly viscous.

The first signs of the formation of a crosslinked network structure in PVDF with the additional LiOH was observed from its cast film, where the PVDF-LiOH cast film was non-soluble in NMP, even after stirring for 24 hours. The crosslinking was also suggested by the negligible shrinkage of the PVDF-LiOH cast film, compared to its PVDF counterpart irrespective of the fact that both PVDF and PVDF-LiOH cast films were flexible.

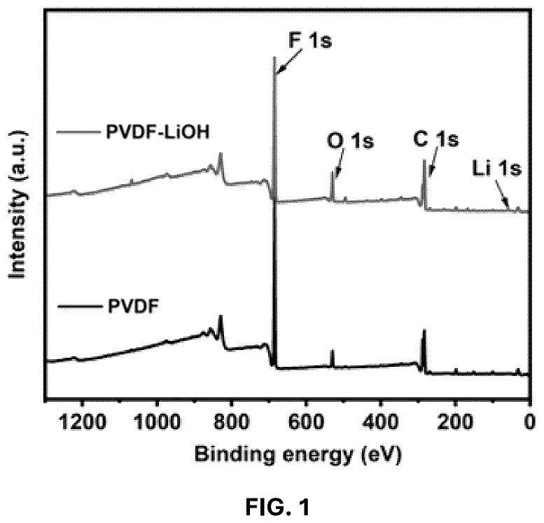

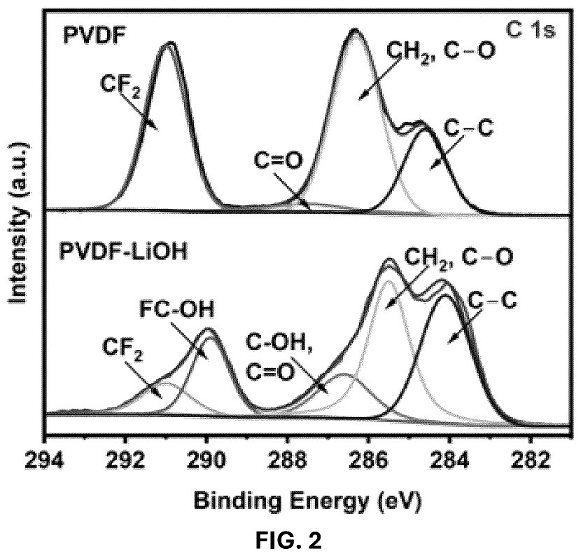

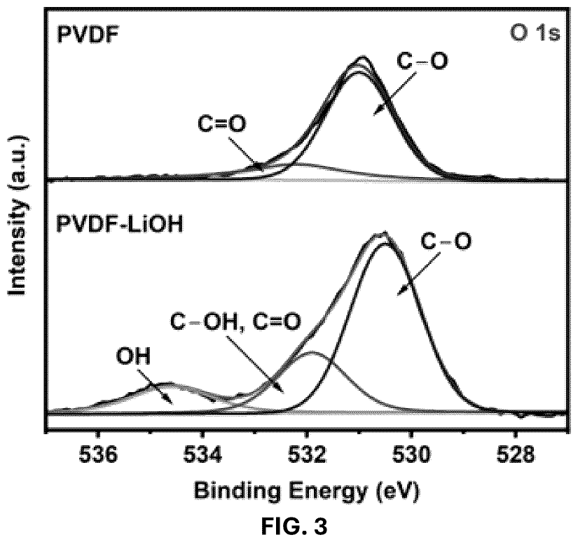

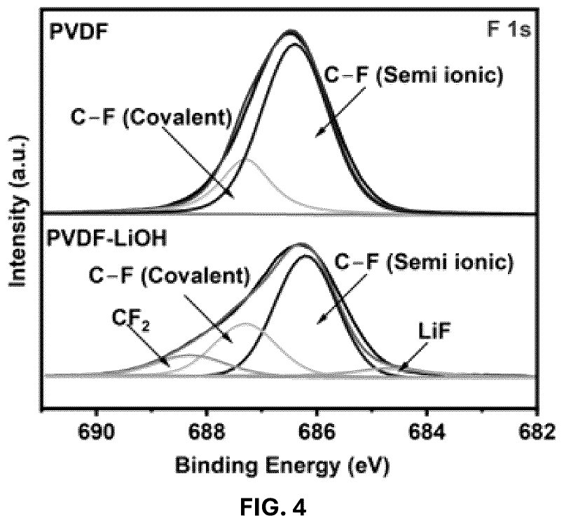

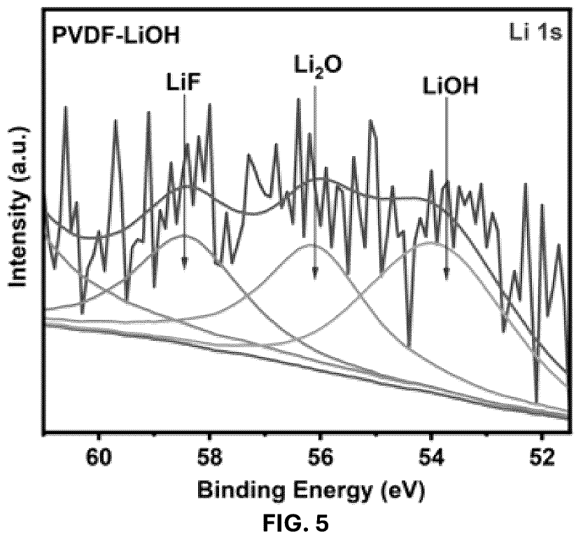

The XPS survey spectra of the PVDF and PVDF-LiOH cast films displayed the presence of C1s, O1s, and F1s for PVDF; however, an additional peak of Li1s was observed in PVDF-LiOH (FIGS. 1 and 5). Considering the elements and the groups directly bonded to the carbon atoms, the high-resolution C1s spectrum (FIG. 2) of PVDF could be deconvoluted into four peaks. Two characteristic peaks centered at 286.3 and 291.0 eV correspond to —CH₂— and —CF₂— groups of PVDF, respectively. Whereas the other two peaks centered at 284.6 and 287.5 eV are ascribed to C—C and C═O, respectively. The C1s spectrum of PVDF-LiOH displayed a relatively high intensity of the C—C peak. Meanwhile the intensity of —CF₂— peak relative to —CH₂— decreased and a new peak appeared at 289.9 eV that corresponds to the formation of F—C—OH. Additionally, the increased intensity of C—OH at 286.6 eV suggests possible formation of H—C—OH. The presence of the aforementioned bonds is also confirmed in the O1s high-resolution spectra of PVDF-LiOH (FIG. 3). The F1s high-resolution spectrum (FIG. 4) showed the presence of LiF in PVDF-LiOH, which was formed as a major byproduct through the reaction of LiOH and HF. This was also evidenced by the Li1s high-resolution spectra (FIG. 5) of PVDF-LiOH, which showed the formation of lithium-based byproducts like LiF and Li₂O with the presence of some unreacted LiOH in PVDF-LiOH cast film.

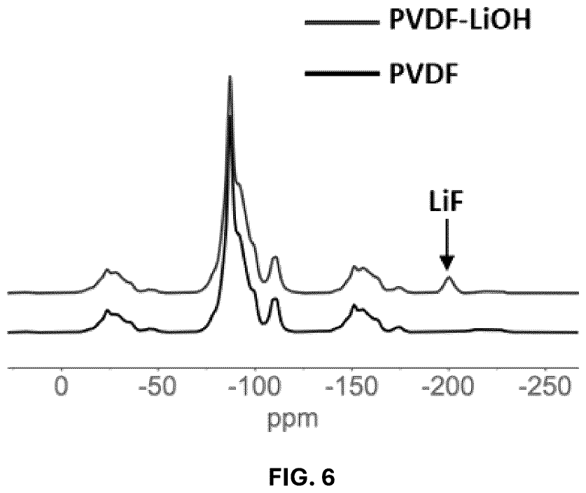

Corroborating the XPS result, the solid-state ¹⁹F magic angle spinning (MAS) NMR spectroscopy (FIG. 6) clearly shows the emergence of LiF peak at −200.17 ppm in PVDF-LiOH. The solid-state ¹³C CP-MAS NMR spectra of the samples were also collected. However, a negligible variation in the ¹³C CP-MAS spectrum between the PVDF and PVDF-LiOH cast films was detected, which suggests a low degree of crosslinking in PVDF-LiOH relative to the polymer chain length. The limited crosslinking is also supported by the reasonable flexibility of PVDF-LiOH cast film even after crosslinking.

### FTIR and XRD Characterizations

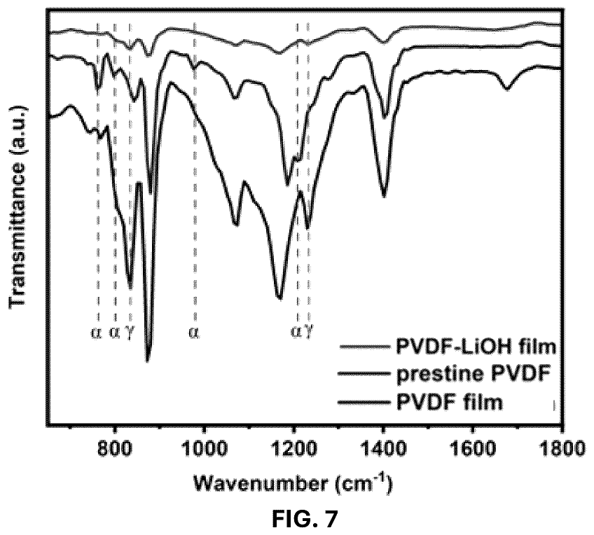

The changes in chemical and compositional characteristics of PVDF-LiOH compared to PVDF were further studied by FTIR and XRD, as displayed in FIGS. 6 and 7. Specific FTIR peaks determine the primary polymorphic form of PVDF, while several common peaks are present in its three typical polymorphs i.e., α, β, and γ. All of the polymorphic phases are present in the pristine PVDF powder with a dominating a phase, confirmed by the exclusive α-phase characteristic absorption peaks at 763 cm⁻¹, 796 cm⁻¹, 976 cm⁻¹, and 1209 cm⁻¹ (FIG. 7). Interestingly, these peaks are not as prominent in the PVDF cast film, which exhibits exclusive peaks for γ-phase at 833 and 1233 cm⁻¹. This is ascribed to the structural rearrangement of PVDF polymer chains due the controlled solvent evaporation during the drying process of the cast film. Because of the strong interaction between PVDF and NMP, even after drying for 24 h, a trace amount of NMP solvent remained in the PVDF film, which resulted in an additional peak at 1678 cm⁻¹ due to the solvent's C═O. This observation accentuates the importance of the NMP drying time during the battery electrode fabrication process when standard PVDF is used as binder.

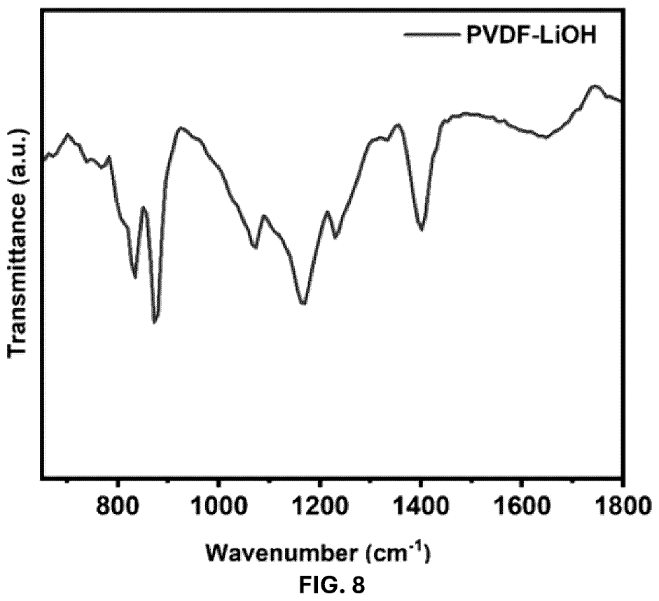

The FTIR spectrum of the PVDF-LiOH cast film, similar to the PVDF cast film, exhibits the γ-phase peaks, yet it is devoid of the NMP peak at 1678 cm⁻¹. Rather, it exhibits a broad peak at 1600 cm⁻¹, more visible in the zoomed in view of the FTIR spectra of PVDF-LiOH in FIG. 8, implying the cross-linking of PVDF in agreement with other reports. The comparison of the FTIR results from PVDF and PVDF-LiOH implies that the addition of the aqueous LiOH solution not only promoted crosslinking of the PVDF polymer chains, but also weakened the interaction between PVDF and NMP, which facilitates faster NMP solvent evaporation—an important factor in battery electrode manufacturing. The advantageous characteristics of the PVDF-LiOH binder for electrode fabrication was further explored by studying the time required for solvent evaporation during the electrode drying process.

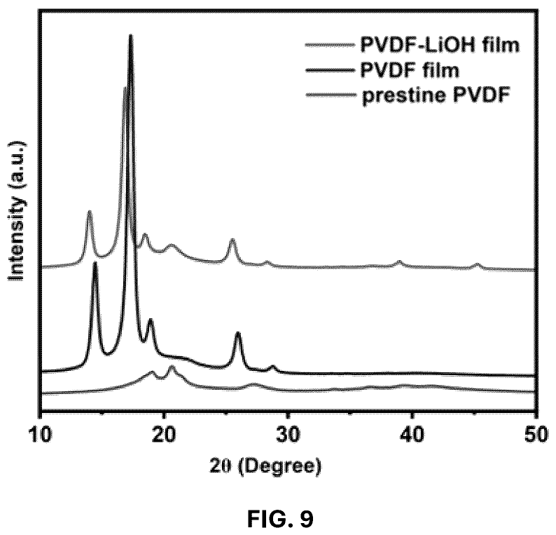

The XRD patterns of the PVDF and PVDF-LiOH cast films confirmed the previous observations. FIG. 9 compares the XRD patterns of the cast films with pristine PVDF powder. The pristine PVDF powder displays three peaks at 19.0°, 20.6°, and 27.2°, which correspond to the diffractions of (020), (110), and (021) planes of α and β phases in PVDF, with a as the more dominant phase. However, those peaks disappear in both PVDF and PVDF-LiOH films diffraction patterns and are replaced by peaks at 17.4°, 18.8°, and 26.0° for the α phase and 21.7° for the β phases as well as lower 20 peaks of around 14±2°, corresponding to the γ phase. The appearance of new peaks α, β, and γ phase indicate a mixture of evolved polymorphic phases. Comparing the PVDF and PVDF-LiOH films XRD patterns, similar peaks are observed in both samples, however, with a notable decrease in the peak intensity of the α and γ phases in the PVDF-LiOH sample. Only the β phase peak at 20.6° becomes more distinctive in the PVDF-LiOH film compared to PVDF film. The changes in the preferred polymorphism and degree of crystallinity are ascribed to the impediment of the polymer chain arrangement in PVDF-LiOH at specific regions due to the formation of crosslinks. Furthermore, and in agreement with the XPS results, the PVDF-LiOH cast film shows two additional peaks at 39.0° and 45.3°, which are associated with the (111) and (200) peaks of LiF.

### Physical and Mechanical Characterizations

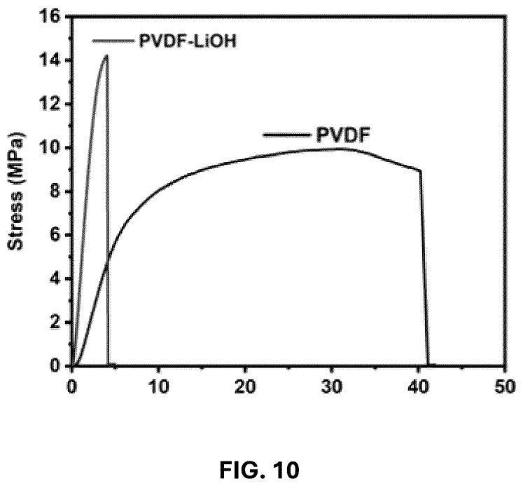

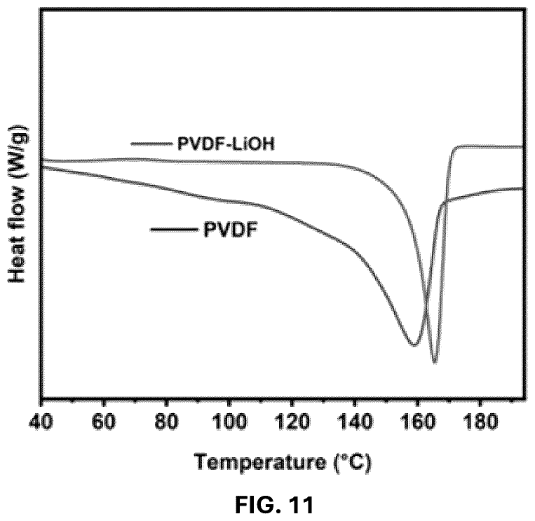

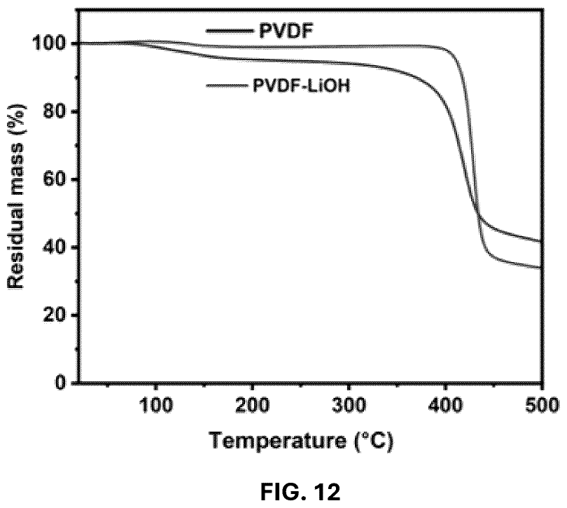

The mechanical properties of electrode binders, such as their tensile strength, stiffness, elongation at break, and alike, are critical parameters that significantly influence the cycle performance of LSB, whose cathode experiences large mechanical stresses during charge and discharge. For that, the stress-strain behavior of the binder films can provide insights into their mechanical properties when used in electrodes. Therefore, the stress-strain curves of PVDF and PVDF-LiOH cast films were investigated. As shown in FIG. 10, an improvement in ultimate tensile strength from 9.8 MPa in PVDF to 14.2 MPa in PVDF-LiOH film was observed. Furthermore, PVDF-LiOH showed higher stiffness and lower elongation at break than PVDF, which is attributed to the formation of a rigid network structure of crosslinked chains. The increase in stiffness was further evidenced by the higher melting temperature (Tm) of PVDF-LiOH compared to PVDF (FIG. 11). The DSC thermograph in FIG. 11 shows that the Tm of PVDF is 158.8° C., whereas Tm of PVDF-LiOH is 165.5° C. The lower Tm of PVDF is ascribed to the higher amount of NMP residue in the PVDF cast film, supported by the results of the NMP evaporation test. Moreover, the TGA thermograph (FIG. 12) shows an initial weight loss in the PVDF cast film. With increasing temperature, PVDF cast film didn't show further weight loss up to 393.5° C., beyond which a sudden weight loss due to its thermal degradation is observed. In contrast, PVDF-LiOH cast film showed an initial weight loss at a lower temperature of around 90° C. due to the moisture loss, followed by a gradual weight loss up to ˜12.5% at 377° C. associated to the decomposition of its Li byproducts. This is while the thermal degradation beyond that temperature is comparatively lower than PVDF, which is attributed to the crosslinked network of PVDF-LiOH.

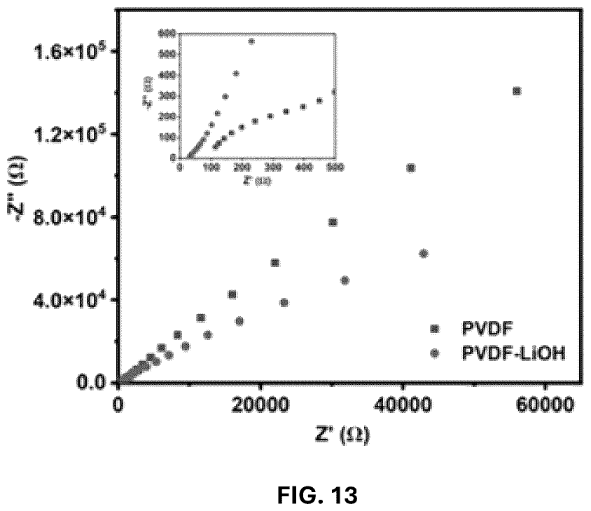

Since the binder covers the surface of electrode particles and provides access for lithium-ions to reach the active sulfur, it is essential to consider the effect of crosslinking on lithium-ion conduction in PVDF. To measure the ionic conductivity, the EIS profiles of PVDF and PVDF-LiOH cast films were collected, as shown in FIG. 13. The cast films were soaked in an electrolyte consisting of DOL/DME (1:1 vol) with 1M LiTFSI and 0.2M LiNO₃ and sandwiched by a pair of stainless-steel disks as the working and counter electrodes in a symmetrical cell format. Ionic conductivity (o) of the cast films were calculated according to the following equation:

$$σ = \frac{d}{{R}_{b} \times S} \qquad ( Eqn . 1 )$$

where d is the thickness of the binder cast films, S is the effective contact area of the cast films with the stainless-steel symmetric electrodes, and Rb represents the internal resistance of electrolyte-soaked cast films. It was confirmed that the PVDF-LiOH exhibits a higher ionic conductivity value of 3.6×10⁻⁵ S cm⁻¹ compared to PVDF with an ionic conductivity of 2×10⁻⁵ S cm⁻¹ at 25° C. The higher ionic conductivity of PVDF-LiOH is attributed to the presence of lithiated compounds including the byproducts of the crosslinking reaction (LiF, Li₂O) and some unreacted LiOH.

### Observed Morphological Changes of Crosslinked Electrode

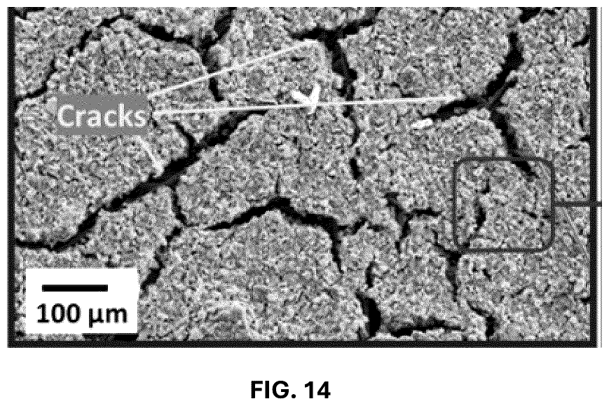

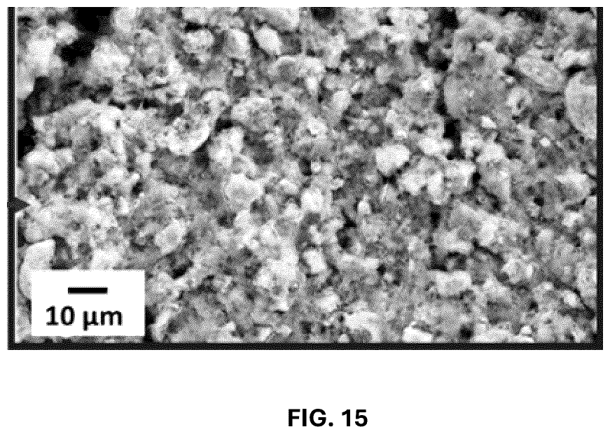

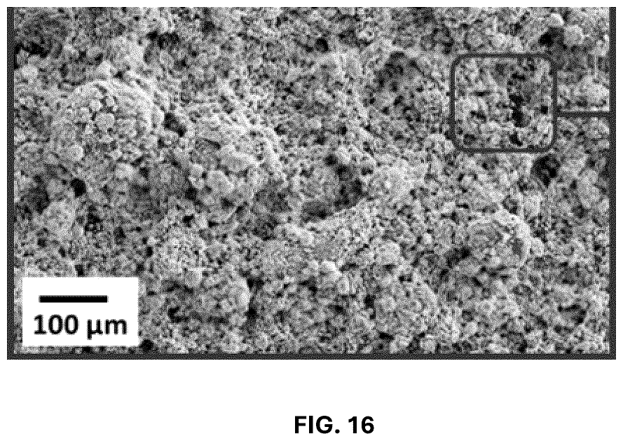

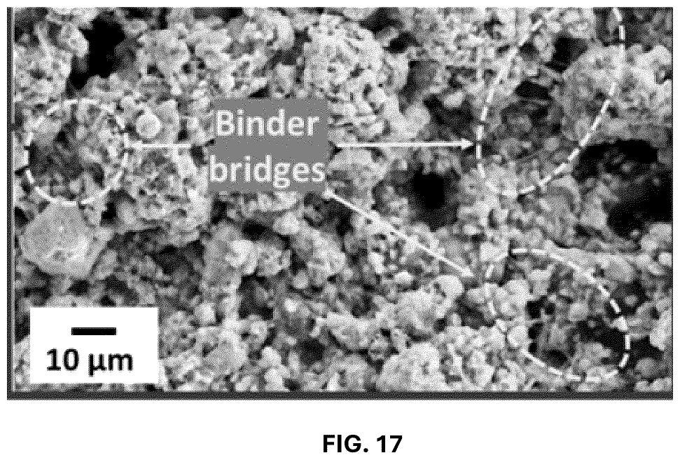

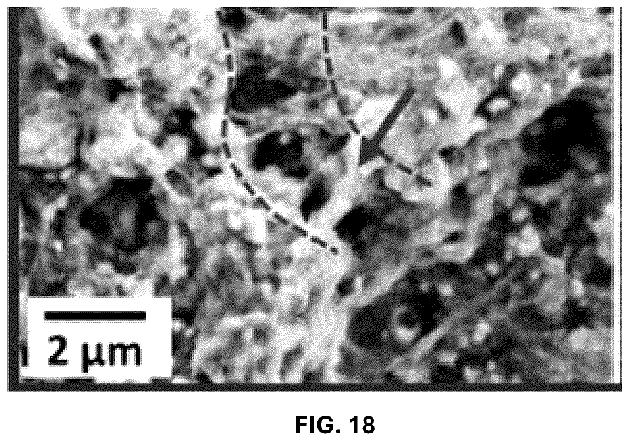

Sulfur cathodes were prepared using the PVDF-LiOH binder through the slurry coating method and compared with standard sulfur cathode using PVDF binder. The cathodes will be denoted as S@PVDF and S@PVDF-LiOH, corresponding to the binder used in them. The sulfur content of the cathodes was 70% with an areal sulfur loading of 3±0.1 mg cm 2. The surface morphologies of the sulfur cathodes were characterized by SEM, as shown in FIGS. 14-18. A noticeable difference in the cathode microstructures was observed depending on the type of binder used in the electrode. S@PVDF cathode exhibited densely packed islands separated by large cracks (FIGS. 14 and 15). The cracks were formed due to the low cohesion forces within the cathode matrix that led to the movement of active material and carbon particles upon the evaporation of solvent during the drying process of electrodes. The electrodes containing Ketjen black, known for its very high surface area thus, high solvent absorbance, experienced a shrinkage stress beyond the mechanical strength of the PVDF binder, which manifested in large cracks. The cracks propagated with the continuous evaporation of the solvent until particles reached their ultimate porosity beyond which the electrode film could not shrink. This resulted in the low porosity of the segregated islands in the electrode, with no to minimal connection between the neighboring islands, and insufficient adhesion/connection between the electrode and the current collector. In contrast, the S@PVDF-LiOH cathode displays a uniform morphology without significant cracks (FIG. 16). The crack initiation and growth are impeded by the faster solvent evaporation during the electrode drying process when S@PVDF-LiOH binder is used. Faster solvent evaporation prevents the active and carbon particles from moving and forming the islands. In addition, the development of crosslinked network in the PVDF-LiOH binder further restricted the movement of electrode particles. More to that point, the web-like binder bridges connecting the electrode particles are visible in the high magnification SEM image of S@PVDF-LiOH (FIGS. 17 and 18), further demonstrating the adhesive effect of the crosslinked PVDF-LiOH binder. EDX elemental distribution maps of F and S further distinguish these binder bridges. The uniform distribution of F in the bridge regions confirms that the adhesive nature of the PVDF-LiOH is responsible for the formation of web-like bridges. Moreover, higher intensity of S present in some of the bridges suggests that the bridge connection not only contains binder, but also sulfur and carbon. As a result of the bridge-like connections, the PVDF-LiOH binder is expected to enhance the porosity of the electrode, while preventing the electrode cracking by restricting the particle movement. The pores can improve the active surface area, facilitate the penetration of liquid electrolytes into the bulk of the electrode for fast ion and mass transportation, and reduce the stress build-up during battery cycling by accommodating the volume expansion of sulfur and its consequent stresses.

### Electrochemical Performance of Crosslinked Electrodes

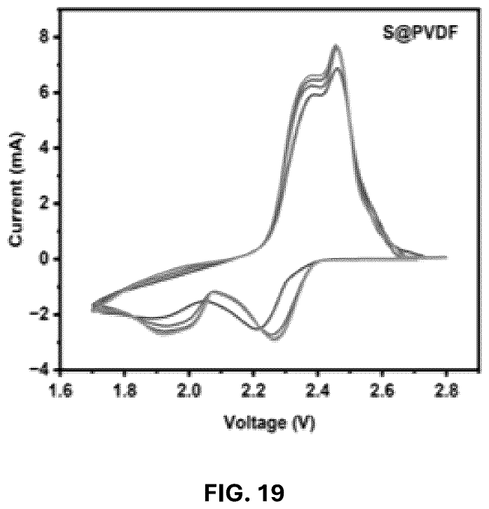

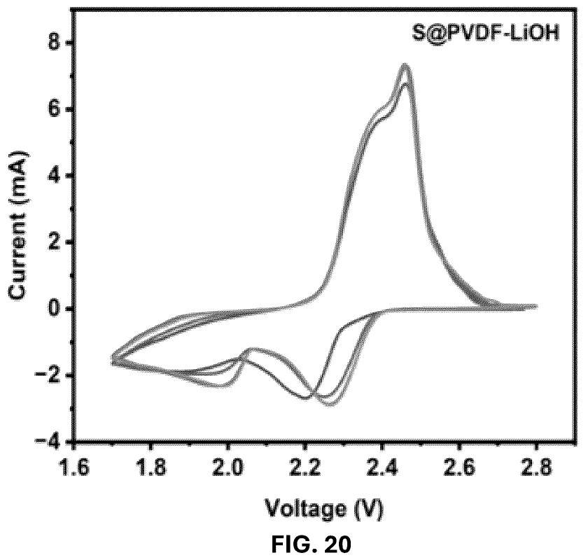

To compare the electrochemical performance of S@PVDF and S@PVDF-LiOH cathodes, LSB cells with an E/S ratio of 10 μL mg⁻¹ were prepared. FIGS. 19 and 20 show the CV curves of the S@PVDF and S@PVDF-LiOH cathodes, respectively, which are conducted at a scan rate of 0.1 mV s⁻¹ between 1.7 and 2.8 V (vs. Li/Li⁺) for the initial four cycles. The CV profiles show two well-defined cathodic peaks in both cells. The peak at ca. 2.26 V is due to the transformation of S₈ to long-chain polysulfides i.e., Li₂Sₙ (4≤n≤8), and the peak at ca. 1.99 V is attributed to further reduction of long-chain polysulfides to short-chain polysulfides and eventually insoluble Li₂S₂/Li₂S. In the subsequent anodic scan, the overlapping oxidation peaks at ca. 2.4 V stands for the inverse process of converting Li₂S₂/Li₂S to Li₂Sₙ (n>2) and further, to S₈. In both S@PVDF and S@PVDF-LiOH cells, a positive shift of the cathodic peaks (towards the anodic peak) from the first cycle to the subsequent cycles is observed which indicates a decrease in the reduction reactions' energy barriers after the initial cycle. Furthermore, higher current values of the cathodic peaks after the first cycle suggests better rate kinetics. However, S@PVDF-LiOH showed a slightly lower CV enclosed area than S@PVDF, suggesting that the transformation of polysulfide species in S@PVDF was faster than S@PVDF-LiOH. Furthermore, the S@PVDF electrode showed more distinctive anodic peaks than the S@PVDF-LiOH, which also indicates faster reaction kinetics due to lower polarization.

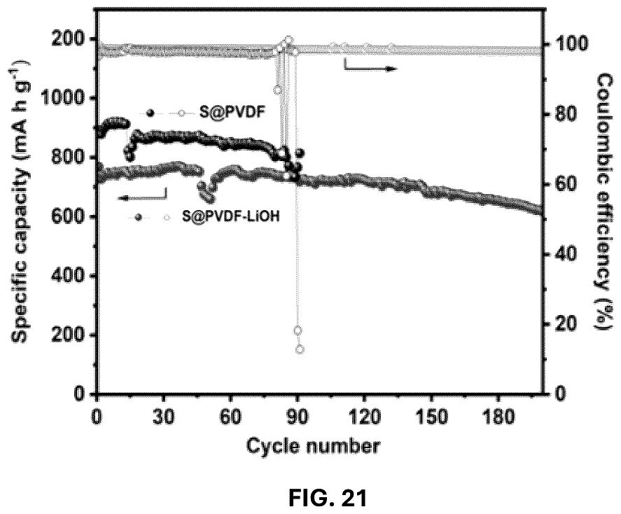

FIG. 21 shows the coin cell cycle performance of the S@PVDF and S@PVDF-LiOH at 0.1 C-rate. S@PVDF-LiOH delivered an initial specific capacity of 767.2 mAh g⁻¹, which was comparatively lower than the S@PVDF (891.2 mAh g⁻¹). The cycling performance is consistent with the cyclic voltammetry results, indicating slightly higher polarization and slower electrochemical conversion of sulfur species in S@PVDF-LiOH. Nevertheless, S@PVDF-LiOH exhibited significantly improved cycle performance, retaining 80.3% of its capacity even after 200 cycles, while S@PVDF failed only after 91 cycles. It is worth noting that PVDF has been reported in sulfur cathodes with cycle lives way beyond 91 cycles. However, those works typically study sulfur cathodes with lower sulfur loadings and/or more expensive and complex cathode recipes involving special carbon materials and host structures. While this work's purpose was to only use inexpensive, and common materials, as well as simple and scalable methods, in energy-dense electrodes for practical use.

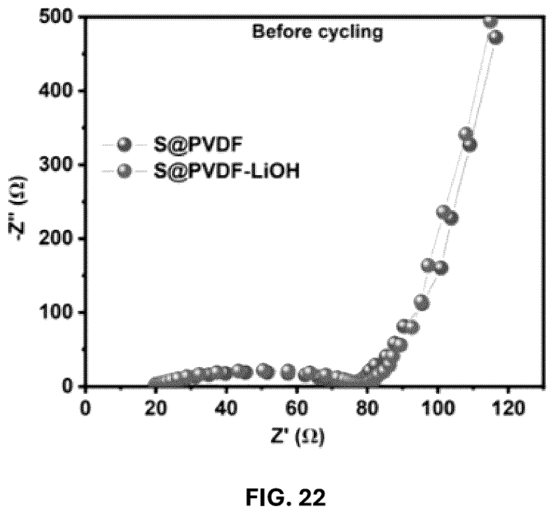

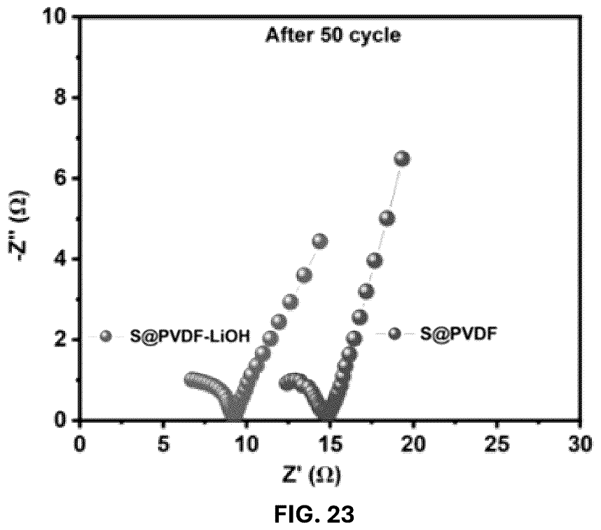

Higher Li⁺ ion conductivity of PVDF-LiOH than PVDF was expected to increase the achieved capacity of the lithium sulfur battery. However, FIG. 21 showed that PVDF-LiOH slowed down the electrochemical conversion of sulfur, manifested in its lowered achieved capacity. Hence, in the next step the internal resistance of the cells was investigated using the EIS technique. The EIS measurements of S@PVDF and S@PVDF-LiOH cells in pristine condition and after 50 cycles at 0.1 C-rate were studied within the frequency range of 10 mHz to 100 KHz. As shown in FIGS. 22 and 23, the Nyquist plots of both cells are composed of a suppressed semicircle in the high to medium-frequency range, which is conventionally referred to as the charge-transfer resistance (R_{ct}), as well as an inclined line in the low-frequency range, which is related to the Warburg impendence (Zw). The intercept of the semicircle with the Z′ (real part of impedance) axis in the high-frequency region is often associated to the resistance of the electrolyte solution (Re). Nevertheless, after 50 cycles, while the R_{ct} decreased for both cells expectedly (due to conditioning of both anode and cathode electrodes), the R_{ct} of cycled S@PVDF-LiOH (4.2Ω) was lower than that of the S@PVDF (6.1Ω). Although the resistance provided by the EIS measurement is not a sole and comprehensive value for the electrical conductivity of the cathode, it provides an ensemble knowledge of the resistances hindering the electrochemical reactions, which are higher in the case of S@PVDF. Similarly, the Re of both cells were nearly identical (19.4 and 20.3Ω) before cycling. Yet, after 50 cycles, the Re of S@PVDF-LiOH (4.9Ω) was almost half of that of the S@PVDF (8.8Ω). This is ascribed to the higher ionic mobility in the electrolyte of the S@PVDF-LiOH cell due to the controlled dissolution of polysulfides, as polysulfide dissolution increases the electrolyte viscosity, thereby lowers the ionic mobility. This result aligns with the superior cyclic stability of the S@PVDF-LiOH, suggesting the suppression of polysulfide dissolution/shuttling manifested by the significant capacity retention.

With higher ionic and electrical conductivity in S@PVDF-LiOH compared to S@PVDF, and similar component and processes in their electrode and cell preparation, it is reasonable to attribute the difference in the S@PVDF and S@PVDF-LiOH cathode performances to their structural and mechanical characteristics affected by their binders. The SEM images complemented by the mechanical and physical property measurements suggested that stiff PVDF-LiOH binder uniformly surrounded the electrode particles, restricting the movement of particles, thus crack formation. Such a stiff binder surrounding the sulfur particles also restricts the volume expansion of sulfur upon lithiation. This stiff binder surrounding the sulfur particles, despite its higher ionic conductivity, impedes the liquid to solid phase transition and deposition of fully discharged sulfur. This limitation leads to slower kinetics and thus, lower specific capacity of S@PVDF-LiOH.

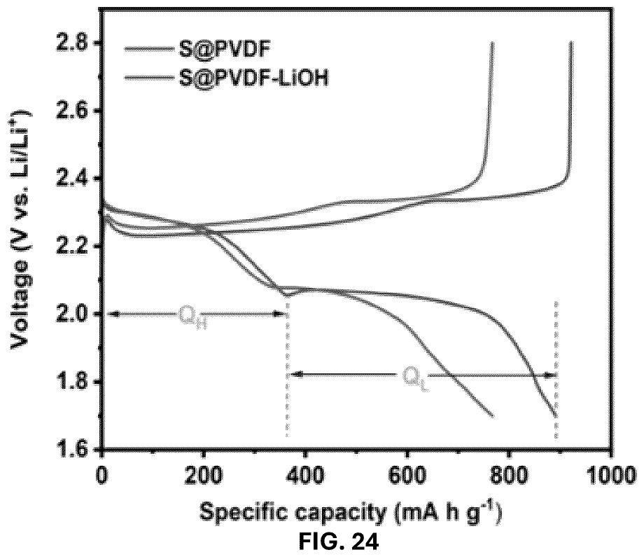

To validate this hypothesis, the first charge-discharge profiles of S@PVDF and S@PVDF-LiOH were scrutinized, as depicted in FIG. 24. The discharge voltage profile of both S@PVDF and S@PVDF-LiOH cells displayed two discharge plateaus with the higher voltage plateau representing the conversion of sulfur to long order polysulfide species while the lower voltage plateau signifies the further conversion of long chain polysulfides to the short chain and solid state Li₂S₂/Li₂S. Negligible differences between the upper-plateau discharge capacities (Q_{H}) of the cells were observed, implying that the transformation of sulfur to higher order polysulfides (Li₂Sₙ, 4≤n≤8) is comparable in the cells. However, the lower-plateau discharge capacity (Q_{L}) of S@PVDF-LiOH was considerably smaller than that of S@PVDF, indicating that it was in fact the conversion of long chain polysulfides to lower order polysulfides (Li₂Sₙ, 1≤n≤4) that became sluggish with S@PVDF-LiOH as binder.

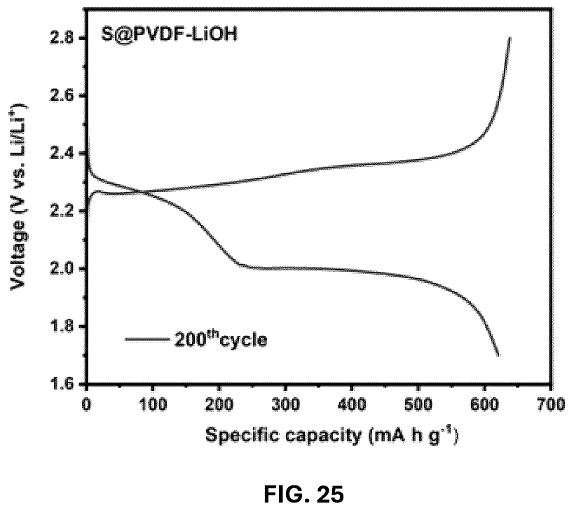

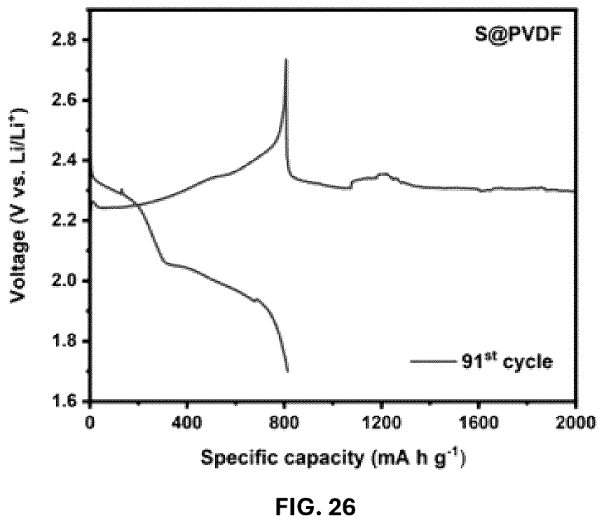

Lithiation-induced volume expansion of sulfur particles starts with the conversion of S₈ to LiPSs from the particle's shell towards its core. Specifically, the volume expansion starts with the formation of Li₂S₈ on the outer shell of sulfur, which then converts to Li₂S₆ and Li₂S₄. In the subsequent stages, both the as-formed shell and unreduced S₈ core further lithiate into Li₂S₄, Li₂S₂, and Li₂S, all of which eventually transform to Li₂S with a total volume expansion of ca. 80%. The suppressed low-voltage plateau in S@PVDF-LiOH suggesting the sluggish formation of lower-order polysulfide, confirms that PVDF-LiOH binder limited those reactions due to its mechanical stiffness. Consequently, this restricted the overall polysulfide formation in subsequent cycles, which in turn prevented the shuttling effect. Moreover, the reduced stresses generated in S@PVDF-LiOH due to the limited volume expansion and their further accommodation by the porous electrode microstructure helped to stabilize the sulfur cathode for an extended number of cycles. On the other hand, the unrestricted electrochemical conversion of sulfur species in S@PVDF led to a higher specific capacity; however, the resulting volume variation caused an early cell failure. Additionally, the denser microstructure of S@PVDF experiences larger internal stress, which leads to its mechanical damage. Therefore, the galvanostatic charge-discharge profiles of S@PVDF-LiOH (FIG. 25) even at 200th cycles showed two typical discharge plateaus and a charge plateau. However, S@PVDF encountered an abnormally extended charge (FIG. 26) on the 91^{st} cycle that resulted in a sudden drop in Columbic efficiency to 12.8% and battery cycling was terminated.

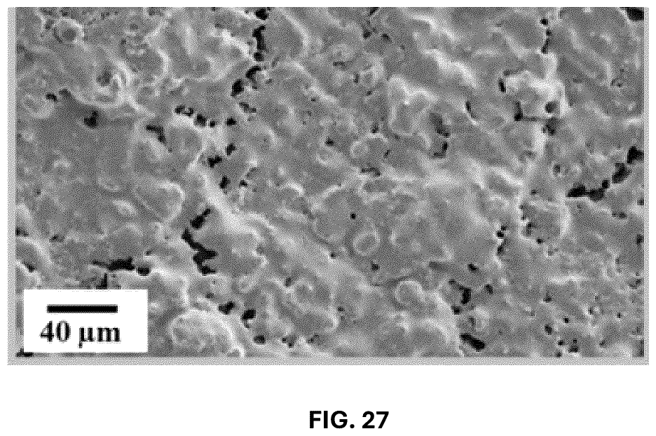

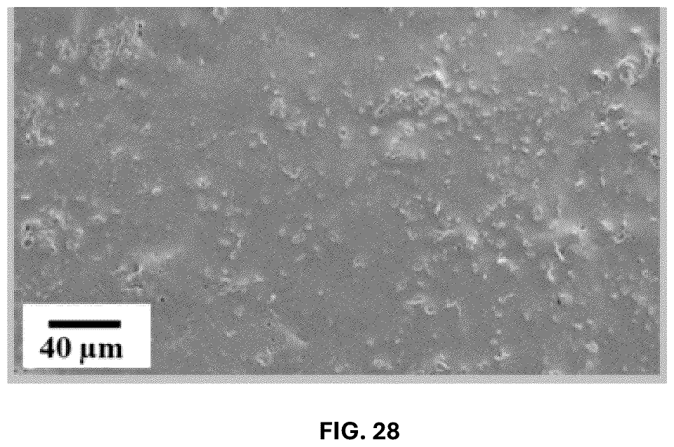

Further post-mortem studies were conducted on both S@PVDF and S@PVDF-LiOH cells after 50 cycles to delve into the effect of crosslinked PVDF-LiOH binder on polysulfide formation and shuttling mechanism. The cycling of the cells was terminated in a fully charged state after completion of the 50th cycle and the cells were disassembled. As shown in FIG. 27, the SEM images of charged S@PVDF cathode revealed the remaining of cracks after 50 cycles which confirms that a substantial amount of polysulfides have dissolved in the liquid electrolyte, instead of transforming to the solid short chain polysulfides that could potentially fill out the cracks. In contrast, the SEM images of the S@PVDF-LiOH cathode, shown in FIG. 28, display a uniform surface morphology due to the homogenous deposition and accumulation of polysulfides in the pores of the cathode without significant loss (supported by the cycle durability).

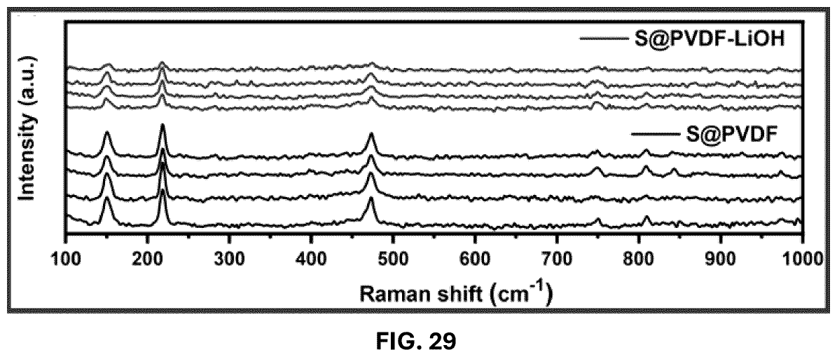

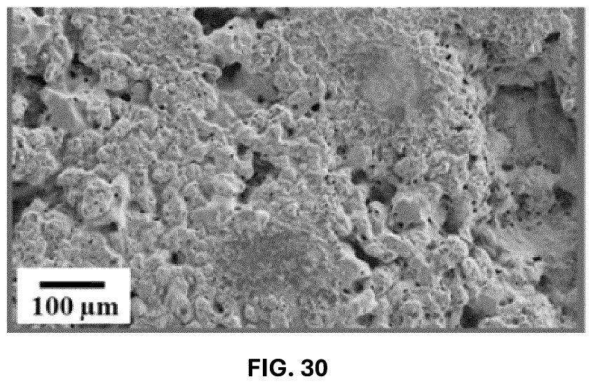

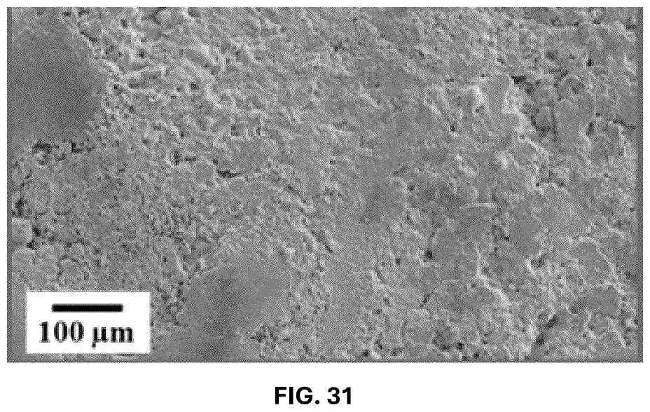

This is further confirmed by comparing the Raman spectroscopy of the separators extracted from the cycled cells. Raman spectra were collected randomly from four different locations of the anode-facing side of the separator and close to the center to avoid the local heterogeneities at the peripheral regions. As shown in FIG. 29, the Raman spectrum of the separator retrieved from the S@PVDF cell exhibits three characteristic Raman bands at 150, 217, and 473 cm⁻¹ corresponding to S₈²⁻. The S₈²⁻ bands indicate the presence of dissolved Li₂S₈ in the liquid electrolyte under the charge state of the LSBs, which has passed through the separator. The separators were tested immediately after disassembly, preventing from complete evaporation of the electrolyte, therefore, allowing the detection of the liquid-state sulfide compounds. The intensity of the corresponding peaks of the dissolved Li₂S₈ in the separator retrieved from the S@PVDF-LiOH cell is significantly smaller than that of the S@PVDF cell. This suggests that the LiPS shuttling was restricted in the S@PVDF-LiOH cathode by the robust crosslinked binder structure. These observations were further validated by exploring the surface of the retrieved Li anode from both cells. The SEM image of the metallic Li anode extracted from the cycled S@PVDF cell (FIG. 30) showed a rough surface morphology corresponding to the substantial formation of Li dendrites due to the parasitic reaction with dissolved LiPSs as well as deposition of LiPSs on the surface of Li anode. However, the surface of the Li anode retrieved from the cycled S@PVDF-LiOH cell (FIG. 31) showed a relatively smooth surface morphology. These results combined prove the hypothesis that PVDF-LiOH binder controlled the polysulfide formation through restricting the lithiation-induced volume expansion and therefore, limited the shuttling effect and the polysulfide mitigated parasitic reaction with the lithium anode, manifested in the high durability of S@PVDF-LiOH cells.

### Effect of Degree of Crosslinking on Electrochemical Performance

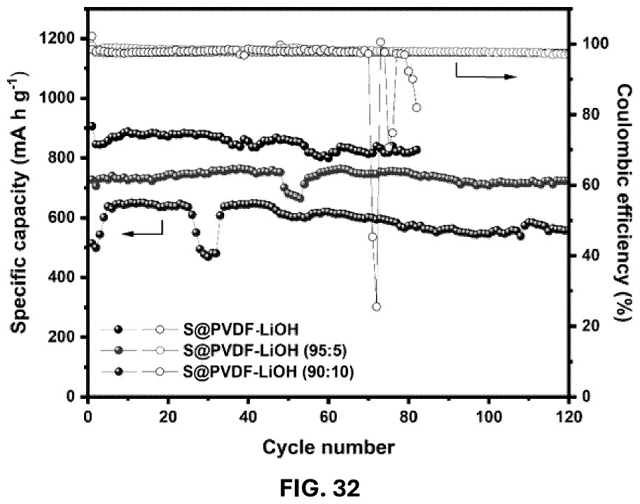

The cathode containing binder with higher degree of crosslinking was prepared by increasing the amount of LiOH in the binder solution. This was achieved by changing the weight percentage of PVDF:LiOH from 95:5 to 90:10. The resulting cathode will be referred to as S@PVDF-LiOH (90:10). Further, the cycle performance of the coin cells with S@PVDF, S@PVDF-LiOH (95:5) and S@PVDF-LiOH (90:10) with an areal sulfur loading of ˜3.3 mg cm⁻¹ at E/S ratio of 10 μL mg⁻¹ was compared. As shown in FIG. 32, the cycle performance of S@PVDF and S@PVDF-LiOH at were consistent with their corresponding cathodes at ˜3 mg cm⁻¹, confirming the repeatability in the performance of the cathodes. Similar to previous tests, S@PVDF failed even prior i.e., only after 82 cycles with a marginal increase in areal sulfur loading (from 3 mg cm⁻¹ to 3.3 mg cm⁻¹), which reminds the unsuitability of PVDF for lithium sulfur batteries with high sulfur loading. Whereas both S@PVDF-LiOH (95:5) and S@PVDF-LiOH (90:10) showed stable cycle performance beyond 120 cycles. However, S@PVDF-LiOH (90:10) displays specific capacities less than S@PVDF-LiOH due to a higher degree of crosslinking that expectedly imposes more restrictions towards the volume expansion of sulfur and thereby, limits the conversion of sulfur species. Therefore, in view of a trade-off between cycle performance and specific capacity, PVDF:LiOH at 95:5 was considered as the optimum binder composition for further studies in practical cell configurations (high sulfur loading in cathode as well as pouch cells).

### Potential Commercial Implementations

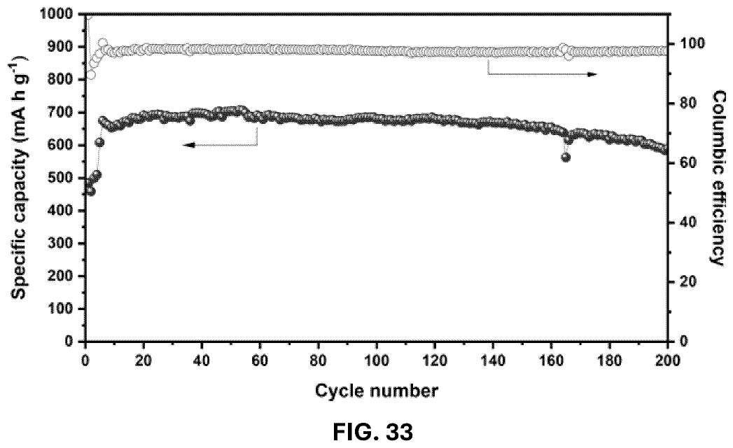

Cathodes with an areal sulfur loading of at least 4 mg cm⁻² are desired. Therefore, to determine the ability of PVDF-LiOH binder in high-sulfur-loading cathodes, the cycle performance of an LSB with S@PVDF-LiOH cathode at an areal sulfur loading of 4 mg cm⁻² and E/S of 9 μL mg⁻¹ was measured. Benefiting from the prime adhesion of electrode particles using the PVDF-LiOH binder, the S@PVDF-LiOH cell witnessed a superb cycle performance at 0.1 C-rate of up to 200 cycles (FIG. 33). Though a low capacity of 484.4 mAh g⁻¹ was delivered in the first cycle due to the limited excess of liquid electrolyte in the bulk of the thick sulfur cathode, the achieved capacity was increased to 703.5 mAh g⁻¹ by the 50th cycle and maintained at 589.2 mAh g⁻¹ at 200th cycles, offering a capacity retention of about 83.8%. However, S@PVDF cells at similar areal loading didn't perform at 0.1 C-rate due to mass-transport limitations at higher areal sulfur loading.

Encouraged by the promising performance of the high-sulfur-loading S@PVDF-LiOH coin cells, a pouch cell with larger area (2×3 cm²) electrodes were also prepared and tested for cycling to investigate the potential of the PVDF-LiOH binder for more practical battery forms. It is worth noting that additional challenges are associated with the large area electrodes in pouch cells such as the non-uniform wetting of electrodes at low E/S ratio, relatively lower active material utilization and significant dendritic growth compared to small size coin cell electrodes. Furthermore, pouch cells are associated with the issues of large internal resistance brought on by the welded tabs and the intricate pouch cell assembly procedures, all of which contribute to the inferior performance of pouch cells compared to coin cells. That known, the pouch cell with a S@PVDF-LiOH cathode at an areal sulfur loading of 3.5 mg cm⁻² and an E/S ratio of 10 μL mg⁻¹ offered a good electrochemical functionality at 0.05 C-rate, reaching an initial discharge capacity of 413.5 mAh g⁻¹ (FIG. 33). Though the capacity slightly dropped after 2 cycles, it was maintained at around 310 mAh g⁻¹ for the rest of the test. The functionality of lithium sulfur battery pouch cell using PVDF-LiOH binder was also showcased by powering a red light-emitting diode (LED) after charging-discharging for 20 cycles.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed:

1. A method for forming an electrode, the method comprising:
dissolving a binder into an organic solvent to provide a dissolved binder; and
adding to the dissolved binder an aqueous solution comprising a metal hydroxide to form a crosslinked binder solution.

2. The method of claim 1, wherein the binder comprises polyvinylidene fluoride.

3. The method of claim 1, wherein the metal hydroxide comprises lithium hydroxide.

4. The method of claim 1, wherein the weight ratio of the binder to the metal hydroxide is between 99 to 1 and 9 to 1.

5. The method of claim 1, wherein the weight ratio of the binder to the metal hydroxide is between 50 to 1 and 19 to 1.

6. The method of claim 1, wherein the weight ratio of the binder to the metal hydroxide is 19 to 1.

7. The method of claim 1, wherein the organic solvent comprises NMP.

8. The method of claim 1, further comprising adding a conductive material to the crosslinked binder solution.

9. The method of claim 1, further comprising adding an electrode active material to the crosslinked binder solution to form an electrode slurry.

10. The method of claim 9, wherein the weight ratio of the electrode active material to the binder is greater than 5 to 1 and less than 30 to 1.

11. The method of claim 9, further comprising coating a current collector with the electrode slurry.

12. An electrode comprising:
an electrode layer comprising
a binder comprising a crosslinked polyvinylidene fluoride having an ionic conductivity greater than 2.5×10⁻⁵ S cm⁻¹;
an electrode active material mixed with the binder; and
a current collector that is coated with the electrode layer.

13. The electrode of claim 12, wherein the electrode active material comprises sulfur.

14. The electrode of claim 12, wherein the electrode active material comprises an alloy oxide.

15. The electrode of claim 12, wherein the electrode active material comprises silicon.

16. The electrode of claim 12, wherein the electrode active material comprises 50 wt. % to 98 wt. % of the electrode layer.

17. The electrode of claim 13, wherein the electrode layer has an areal sulfur loading greater than 4 mg cm 2.

18. The electrode of claim 12, wherein the electrode layer further comprises a conductive material.

19. The electrode of claim 12, wherein the electrode layer further comprises carbon black.

20. The electrode of claim 12, wherein the electrode layer further comprises multi-walled carbon nanotubes.

21. A battery comprising:
first and second electrodes, wherein at least one of the electrodes comprise an electrode layer comprising a crosslinked polyvinylidene fluoride binder and an electrode active material, and wherein the first and second electrodes comprise first and second current collectors;
a separator disposed between the first and second electrodes;
an electrolyte in contact with the first and second electrodes and the separator; and
a housing retaining the first and second electrodes, the electrolyte and the separator.

22. The battery of claim 21, wherein the electrode active material of the first electrode comprises sulfur.

23. The battery of claim 22, wherein the sulfur to electrolyte ratio is greater than 9.5 mg μL⁻¹.

24. The battery of claim 22, wherein the areal loading of sulfur is greater than 4 mg cm⁻².
